(19) United States
(12) Patent Application Publication
(10) Pub. No.: US 2026/0221119 A1
(43) Pub. Date: Jul. 30, 2026

(54) METHOD AND DEVICE FOR REDUCING DISPLAY ENERGY BY USING SPATIALLY ALTERNATING COMPLEMENTARY COLORS

(71) Applicant: InterDigital CE Patent Holdings, SAS, Paris (FR)

(72) Inventors: Laurent BLONDE, THORIGNE-FOUILLARD (FR); Claire-Helene DEMARTY, MONTREUIL LE GAST (FR); Franck AUMONT, VERN SUR SEICHE (FR); Olivier LE MEUR, TALENSAC (FR); Erik REINHARD, HEDE-BAZOUGES (FR)

(21) Appl. No.: 19/141,922

(22) PCT Filed: Dec. 12, 2023
(86) PCT No.: PCT/EP2023/085303

§ 371 Date: Jun. 20, 2025

(30) Foreign Application Priority Data
Dec. 22, 2022 (EP) 22306997.2

(51) Int. Cl. G09G 5/06; G09G 3/20; G09G 3/3208

(52) U.S. Cl. CPC G09G 5/06; G09G 3/2003; G09G 3/3208; G09G 2320/0242; G09G 2320/0666; G09G 2330/021; G09G 2340/0414; G09G 2340/0421; G09G 2340/06

(57) ABSTRACT

A method and device allow to reduce the energy or power consumption needed for rendering an image by replacing a pair of adjacent pixels of the image by pixels of spatially alternating complementary colors requiring less energy for display, in other words, by setting the colors of a pair of adjacent pixels of the image to a pair of spatially alternating complementary colors requiring less energy for display. Such solution is exploiting the spatial fusion characteristic of the human vision system that perceives complementary neighboring pixels as a single pixel. The spatially alternating complementary colors are selected to be more frugal than a single color in terms of power consumption required for rendering the color. This combination doubles the search space dimension for energy reduction from three to six. The technique used for replacing a pixel by adjacent pixels of spatially alternating complementary colors is performed either by pixel doubling, by pixel skipping or by pixel averaging. The association between a color and the corresponding spatially alternating complementary colors can be stored in a look-up table. These principles may be used on an image or a video comprising a succession of images.

### CROSS-REFERENCE TO RELATED APPLICATIONS

This application claims the priority to European Application No 22306997.2 filed 22 Dec. 2022, which is incorporated herein by reference in their entirety.

### TECHNICAL FIELD

At least one of the present embodiments generally relates to reducing energy consumption in display devices and more particularly to a method and device that reduces the energy needed for rendering an image by setting the colors of a pair of adjacent pixels of the image to a pair of spatially alternating complementary colors requiring less energy for display.

### BACKGROUND

Reducing energy consumption of electronic devices has become a requirement not only for manufacturers of electronic devices but also to limit, as much as possible, the environmental impact and to contribute to the emergence of a sustainable display industry. The increase in display resolution from SD to HD, then to 4K and in the near future to 8K and beyond, as well as the introduction of high dynamic range imaging, has brought about a corresponding increase in energy requirements of display devices. This is not consistent with the global need to reduce energy consumption knowing that a huge number of devices has a display (i.e., TV, Mobile phones, tablets, etc.). Indeed, displays are the most important source of energy consumption for consumer electronic devices, either battery-powered (e.g., smartphones, tablets, head-mounted displays, car display screens) or not (e.g., television sets, advertisement display panels).

Different display technologies have been developed in the recent years. Although modern displays consume energy in a more controllable and efficient manner than older displays, they remain the most important source of energy consumption in a video chain.

Organic Light Emitting Diode (OLED) is one example of display technology that is getting more and more popular because of numerous advantages compared to former technologies such as Thin-Film Transistor Liquid Crystal Displays (TFT-LCDs). Rather than using a uniform backlight, OLED displays are composed of individual LEDs as image pixels. OLED's power consumption is therefore highly correlated to the image content and the power consumption for a given input image can be estimated by considering the values of the displayed image pixels.

Although OLED displays consume energy in a more controllable and efficient manner, they are still the most important source of energy consumption in the video chain. Different techniques have been developed for reducing the energy needed to display images on a display device. Up to now, most of the solutions to the problem of reducing the energy of displaying some image pulses have targeted the modification of the colors of each frame of the pulses, by a small amount, in luminance and/or color. These solutions therefore limit the number of dimensions to be explored to find more energy frugal images: for a pixel color, they propose another pixel color, limiting the search space dimensions to the three-color channels.

### SUMMARY

Embodiments described hereafter have been designed with the foregoing in mind and describe a method and device for reducing the energy (i.e., power consumption) needed for rendering an image by setting the colors of a pair of adjacent pixels of the image to a pair of spatially alternating complementary colors requiring less energy for display. Such a solution is exploiting the spatial fusion characteristic of the human vision system that perceives complementary neighboring pixels as a single pixel. The spatially alternating complementary colors are selected to be more frugal than a single color in terms of power consumption required for rendering the color. This combination doubles the search space dimension for energy reduction from three to six. The technique used for replacing a pixel by adjacent pixels of spatially alternating complementary colors is performed either by pixel doubling, by pixel skipping or by pixel averaging. The association between a color and the corresponding spatially alternating complementary colors can be stored in a look-up table. These principles may be used on an image or a video comprising a succession of images.

A first aspect of at least one embodiment is directed to a method comprising determining a pair of alternating complementary colors based on the input color of the pixel, wherein an average color of the pair of alternating complementary colors is identical or perceptually similar to the input color and wherein a sum of the energies consumed by displaying a pair of pixels having alternating complementary colors is lower than twice the energy consumed by displaying a pixel having the input color. A variant of the first aspect further comprises iterating multiple times to generate a set of pairs of alternating complementary colors and further comprises selecting the pair of alternating complementary colors of the set of pair of alternating complementary colors having a lowest energy consumption when displayed. A further variant of the first aspect comprises iterating over a set of input colors comprising the colors of all pixels of an input image or of a subset of all pixels of the input image or over all possible color values of a selected color space or a subset of all possible color values of a selected color space. A further variant of the first aspect comprises storing an association between a set of input colors and a corresponding determined pair of alternating complementary colors.

A second aspect of at least one embodiment is directed to a method comprising obtaining a pair of adjacent pixels of an image, obtaining a pair of alternating complementary colors based on colors of the pair of the adjacent pixels according to the first aspect, and setting the color of the first pixel of the pair of adjacent pixels to the first color of the pair of spatially alternating complementary colors and the color of the second pixel of the pair of adjacent pixels to the second color of the pair of spatially alternating complementary colors. A variant of the first aspect further comprises adding new pixels to double the width or height of the image prior to transform a single pixel into a pair of adjacent pixels and where the pair of adjacent pixels is a horizontal or a vertical pair. A variant of the first aspect further comprises skipping one pixel of the pair of adjacent pixels and wherein the pair of spatially alternating complementary colors is based on the color of the non-skipped pixel of the pair of adjacent pixels. A variant of the first aspect further comprises selecting the pair of spatially alternating complementary colors is based on an average color between colors of the first and second pixels of the pair of adjacent pixels.

A third aspect of at least one embodiment is directed a method comprising obtaining a pair of adjacent pixels of an image or video, obtaining a pair of alternating complementary colors according to the first aspect, when the pixel is spatially comprised in a region of interest selected according to a criterion, setting the colors of the pair of adjacent pixels of the image or video to spatially alternating complementary colors wherein the first pixel of the pair of adjacent pixels is set to the first color of the pair of alternating complementary colors and the second pixel of the pair of adjacent pixels is set to the second color of the pair of alternating complementary colors, wherein the selection criterion is a spatio-temporal just noticeable difference map or a motion field or a saliency map or based on eye-tracking or based on attention modelling or is metadata based.

A fourth aspect of at least one embodiment is directed to a device comprising one or more processors configured to, for an input color in an image, determine a pair of alternating complementary colors based on the input color of the pixel, wherein an average color of the pair of alternating complementary colors is identical or perceptually similar to the input color and wherein a sum of the energies consumed by displaying a pair of pixels having alternating complementary colors is lower than twice the energy consumed by displaying a pixel having the input color. A variant of the first aspect further comprises selecting a color value for a first color of the pair of alternating complementary colors according to a selection criterion and determining a second color of the pair of spatially alternating complementary colors based on the selected first color value and on the input color, wherein the selection criterion is a maximal color distance from the input color or that the color is a saturated color or that the color is a greyscale color or that the color has the same luminance than the input color. A variant of the first aspect further comprises iterating multiple times to determine of the pairs of colors by generating a set of pairs of spatially alternating complementary colors and further comprising selecting the pair of spatially alternating complementary colors of the set of pair of spatially alternating complementary colors having the lowest energy consumption, wherein the iteration is done over a set of input colors comprising the colors of all pixels of an input image or of a subset of all pixels of the input image or on a set of input colors comprising all possible color values of a selected color space or a subset of all possible color values of a selected color space and wherein an association between the set of input colors and the corresponding determined pair of spatially alternating complementary colors is stored in a look-up table using an input color as index.

A fifth aspect of at least one embodiment is directed to a device comprising one or more processors configured to obtain a pair of adjacent pixels of an image, obtain a pair of alternating complementary colors based on colors of the pair of the adjacent pixels according to the first aspects, and set the colors of the pair of adjacent pixels of the image or video to spatially alternating complementary colors wherein the first pixel of the pair of adjacent pixels is set to the first color of the pair of alternating complementary colors and the second pixel of the pair of adjacent pixels is set to the second color of the pair of alternating complementary colors. A variant of the first aspect further comprises adding new pixels to double the width or height of the image prior to transform a single pixel into a pair of adjacent pixels and where the pair of adjacent pixels is a horizontal or a vertical pair. A variant of the first aspect further comprises skipping one pixel of the pair of adjacent pixels and wherein the pair of alternating complementary colors is based on the color of the non-skipped pixel of the pair of adjacent pixels. A variant of the first aspect further comprises selecting the pair of alternating complementary colors is based on an average color between colors of the first and second pixels of the pair of adjacent pixels.

A sixth aspect of at least one embodiment is directed to a device comprising a processor configured to obtain a pair of adjacent pixels of an image or video, obtain a pair of spatially alternating complementary colors according to the first aspect, when the pixel is spatially comprised in a region of interest selected according to a criterion, set the colors of the pair of adjacent pixels of the image or video to spatially alternating complementary colors wherein the first pixel of the pair of adjacent pixels is set to the first color of the pair of spatially alternating complementary colors and the second pixel of the pair of adjacent pixels is set to the second color of the pair of spatially alternating complementary colors, wherein the selection criterion is a spatio-temporal just noticeable difference map or a motion field or a saliency map or based on eye-tracking or based on attention modelling or is metadata based.

A seventh aspect of at least one embodiment is directed to a computer program comprising program code instructions executable by a processor, the computer program implementing at least the steps of a method according to the first aspect.

An eighth aspect of at least one embodiment is directed to a non-transitory computer readable medium comprising program code instructions executable by a processor, the computer program product implementing at least the steps of a method according to the first aspect.

### BRIEF DESCRIPTION OF THE DRAWINGS

FIG. 1 illustrates a block diagram of an example of display device in which various aspects and embodiments are implemented.

FIG. 2A illustrates the normalized response spectra of human cones (or spectral sensitivity functions).

FIG. 2B illustrates examples of contrast sensitivity functions (CSF).

FIG. 3 illustrates examples of decomposition of colors into spatially alternating complementary colors according to embodiments.

FIG. 4 illustrates an example of process for reducing the energy consumption for a pixel of an image using spatially alternating complementary colors according to embodiments.

FIG. 5 illustrates an example of process for establishing the pair candidates of spatially alternating complementary colors according to a first embodiment.

FIG. 6 illustrates an example of process for establishing the pair candidates of spatially alternating complementary colors according to a second embodiment in a color space providing color transforms and inverse color transforms.

FIG. 7 illustrates examples of replacement of a pair of adjacent pixels by a pair of pixels of spatially alternating complementary colors according to an embodiment based on resolution increasing.

FIGS. 8A and 8B illustrate examples of adjacent pixel replacement by pixels of spatially alternating complementary colors according to an embodiment based on pixel skipping.

FIG. 9 illustrates examples of color replacement by spatially alternating complementary colors according to an embodiment based on pixel averaging.

FIG. 10 illustrates an example of process for generating a look-up table for spatially alternating complementary colors according to embodiments and an example of process for modifying an image using the look-up table according to embodiments.

FIG. 11 illustrates two examples of deployment for the spatially alternating complementary color process according to embodiments.

### DETAILED DESCRIPTION

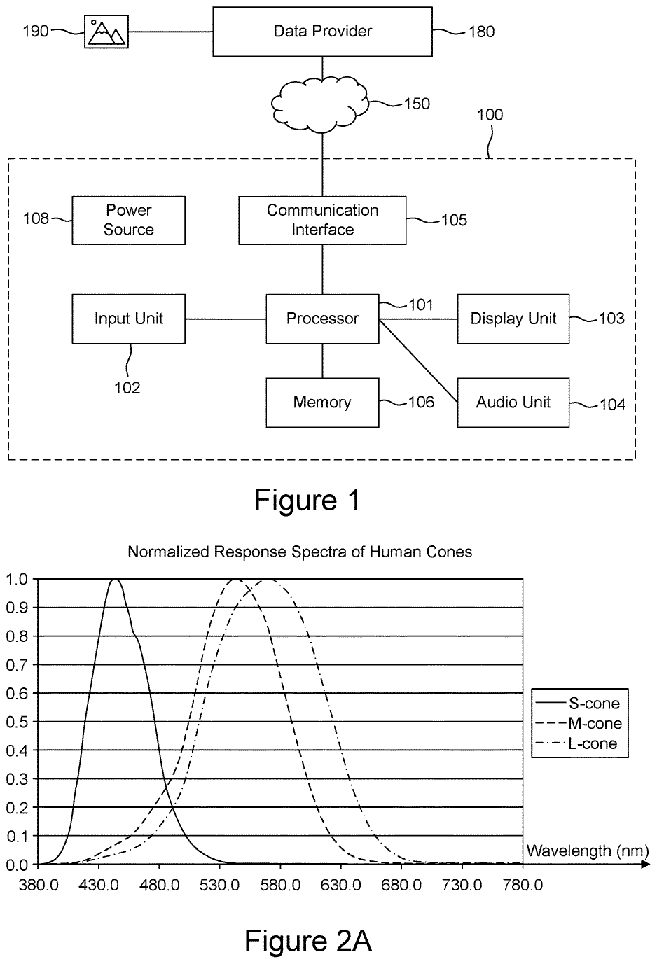

FIG. 1 illustrates a block diagram of an example of display device in which various aspects and embodiments are implemented. In the depicted environment, a user interacts with the display device 100 that is connected to a data provider 180 through a communication network 150.

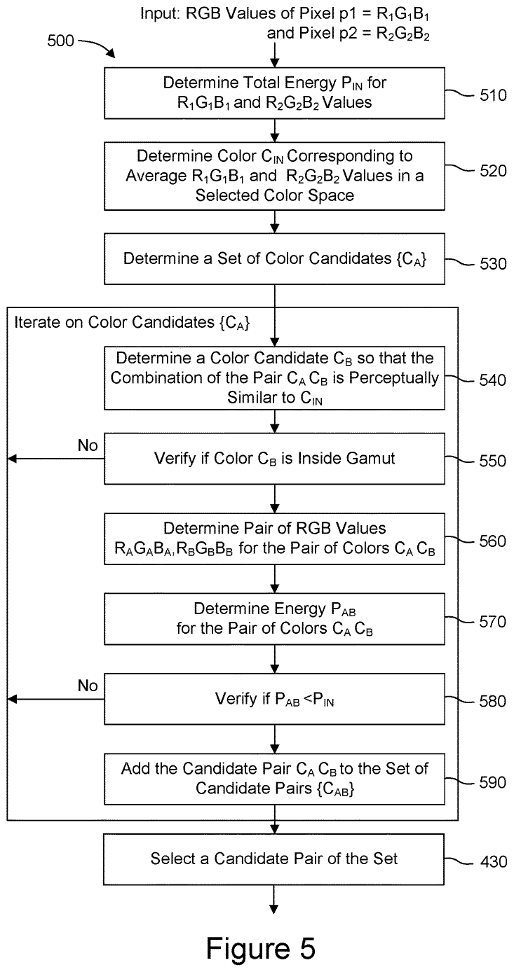

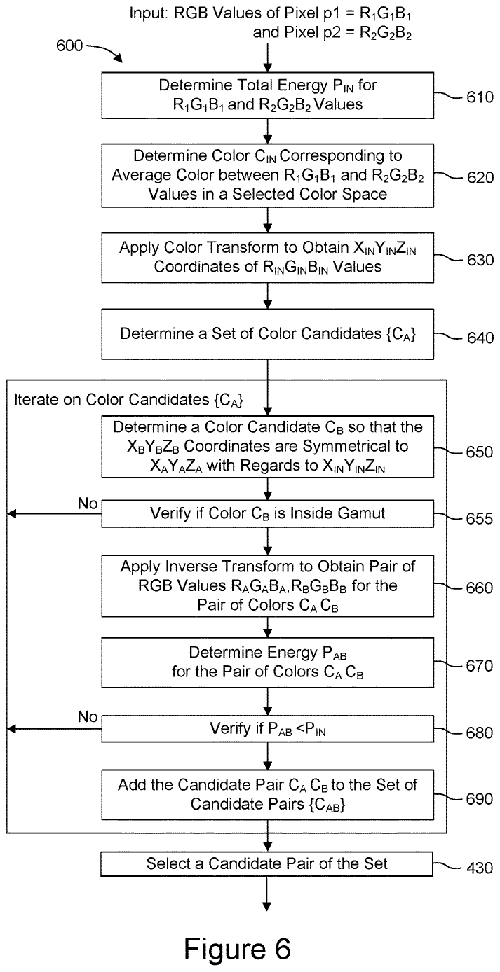

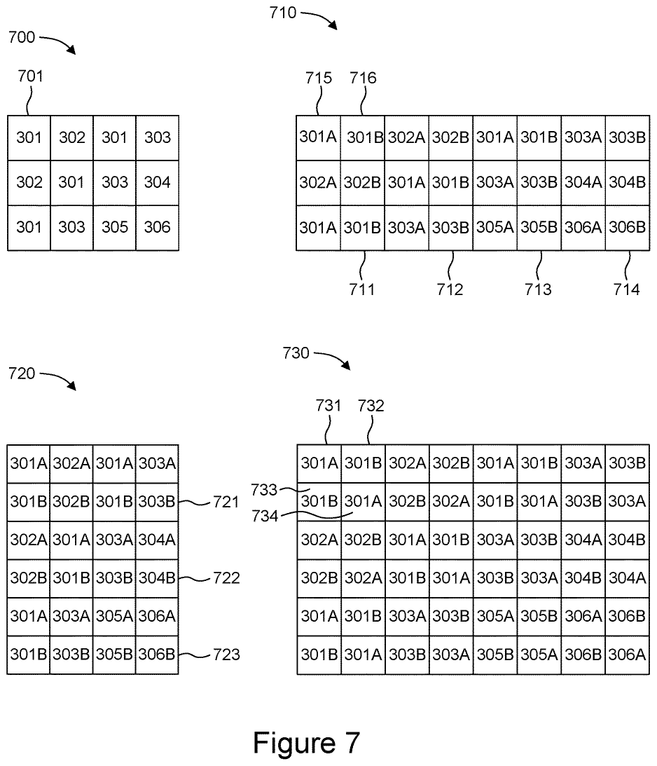

The display device 100 comprises a processor 101. The processor 101 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor may perform data processing such as the process 400 of FIG. 4, the process 500 of FIG. 5 or the process 600 of FIG. 6 and its related embodiment operating in a uniform color space.

The processor 101 may be coupled to an input unit 102 configured to convey user interactions. Multiple types of inputs and modalities can be used for that purpose. Physical keypad or a touch sensitive surface are typical examples of input adapted to this usage although voice control could also be used. In addition, the input unit may also comprise a digital camera able to capture still pictures or video in two dimensions or a more complex sensor able to determine the depth information in addition to the picture or video and thus able to capture a complete 3D representation.

The processor 101 may be coupled to a display unit 103 configured to output visual data to be displayed on a screen. Multiple types of displays can be used for that purpose such as organic light-emitting diode (OLED) display unit. The processor 101 may also be coupled to an audio unit 104 configured to render sound data to be converted into audio waves through an adapted transducer such as a loudspeaker for example.

The processor 101 may be coupled to a communication interface 105 configured to exchange data with external devices. The communication preferably uses a wireless communication standard to provide mobility of the display device, such as cellular (e.g., LTE) communications, Wi-Fi communications, and the like.

The processor 101 may access information from, and store data in, the memory 106, that may comprise multiple types of memory including random access memory (RAM), read-only memory (ROM), a hard disk, a subscriber identity module (SIM) card, a memory stick, a secure digital (SD) memory card, any other type of memory storage device. In embodiments, the processor 101 may access information from, and store data in, memory that is not physically located on the device, such as on a server, a home computer, or another device.

The processor 101 may receive power from the power source 108 and may be configured to distribute and/or control the power to the other components in the device 100. The power source may be any suitable device for powering the device. As examples, the power source may include one or more dry cell batteries (e.g., nickel-cadmium (NiCd), nickel-zinc (NiZn), nickel metal hydride (NiMH), lithium-ion (Li-ion), and the like), solar cells, fuel cells, and the like.

While the figure depicts the processor 101 and the other elements 102 to 108 as separate components, it will be appreciated that these elements may be integrated together in an electronic package or chip. It will be appreciated that the display device 100 may include any sub-combination of the elements described herein while remaining consistent with the embodiments described hereafter. The processor 101 may further be coupled to other peripherals or units not depicted in FIG. 1 which may include one or more software and/or hardware modules that provide additional features, functionality and/or wired or wireless connectivity. For example, the peripherals may include a universal serial bus (USB) port, a vibration device, a television transceiver, a hands-free headset, a Bluetooth® module, a frequency modulated (FM) radio unit, a digital music player, a media player, a video game player module, an Internet browser, and the like. For example, the processor 101 may be coupled to a localization unit configured to localize the display device within its environment. The localization unit may integrate a GPS chipset providing longitude and latitude position regarding the current location of the display device but also other motion sensors such as an accelerometer and/or an e-compass that provide localization services.

Typical examples of display device 100 are smartphones, tablets, laptops, external monitors, head-mounted displays, television set, video projectors, computer screens, vehicles (e.g., control and/or entertainment systems for cars, planes, boats, etc.), advertisement display panels, medical monitors, etc. However, any device or composition of devices that provides similar functionalities can be used as display device 100 while still conforming with the principles of the disclosure. In at least one embodiment, the device does not include a display unit but prepares data for display so that another device, such as a screen, can perform the display. Example of such devices are set top boxes, media players, desktop computers, encoders, decoders, servers, computing grids, cloud computers, etc.

Embodiments below describe a method to modify a pair of color pixels to reduce the energy needed to display the modified pixels on a display device while preserving as much as possible the visual similarity with the original pair of pixels and quality of experience. Embodiments exploit the principle of visual and spatial fusion and propose to set the colors of a pair of adjacent pixels of the image to a pair of spatially alternating complementary colors requiring less energy for display. The pair of spatially alternating complementary colors is selected so that the average color of the pair of colors is perceptually similar/identical to an input color or an average of input colors and the energy of the pair of colors is lower than the energy of the input color. The term “energy of the color” should be understood here as the energy needed for rendering a pixel of the color. Different types of spatial replacement are described: pixel doubling, pixel skipping and pixel averaging.

State of art solutions propose to select a color consuming less energy, for example by reducing the overall luminance of the pixels or reducing the level of some color components. Using pairs of colors has the advantage of versatility, the selection of colors of the pair being done based on two parameters: energy consumption and visual matching to the initial color. This method increases the search space for lower energy colors and therefore increases the probability to have a combination that reduces the energy more significantly. It also provides an image with better quality of experience, i.e., better similarity compared to the state of art solutions.

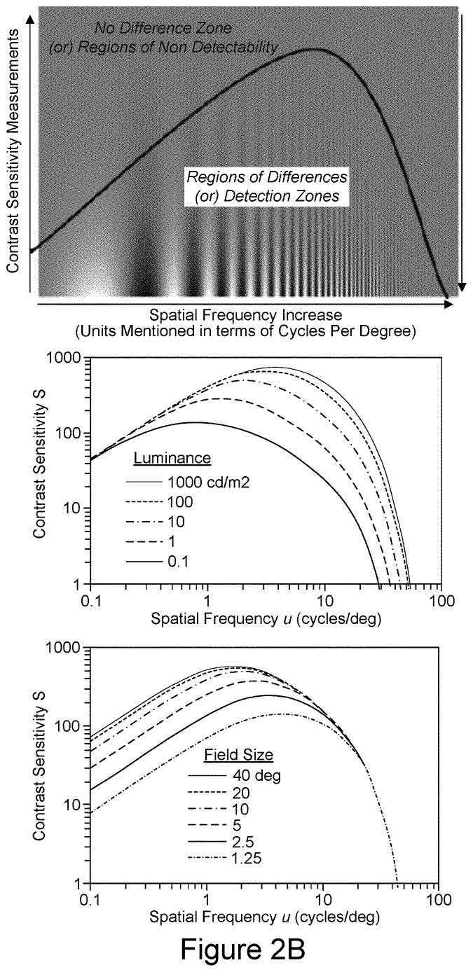

FIG. 2A illustrates the normalized response spectra of human cones (or spectral sensitivity functions). Electromagnetic radiation is characterized by its wavelength (or frequency) and its intensity. The range of wavelengths humans can perceive is approximately from 380 nm to 780 nm. When the wavelength is within this range, it is known as “visible light”. Perception of color is based upon the varying sensitivity of different cells in the retina (color receptors: cones and rods) to light of different wavelengths. Human observers have three types of color receptors, known as cone cells. This confers trichromatic color vision, cones being usually labeled either according to the wavelengths of the peaks of their spectral sensitivities: short(S), medium (M), and long (L), or simply according to the primary colors those peaks are centered on: Blue, Green, or Red as illustrated in FIG. 2A.

Trichromatic theory teaches us that the color a human observer perceives of a light spectrum can be characterized by 3 single scalar values. From a mathematical point a view, this initial step of human vision could be compared to that of a triple-kernel energy computation process. Let si(λ) be the wavelength response of a given light spectrum, and l(λ), m(λ), and s(λ) be respectively the spectral sensitivity functions of the L, M, and S cones, equation 1 below defines Li, Mi, and Si. These are the 3 scalar values that characterize the color of spectrum si(λ) seen by a human observer.

$${L}_{i} = {\int }_{- ∞}^{+ ∞} {s}_{i} ( λ ) \cdot l ( λ ) d λ \qquad ( 1 )$$

$${M}_{i} = {\int }_{- ∞}^{+ ∞} {s}_{i} ( λ ) \cdot m ( λ ) d λ$$

$${S}_{i} = {\int }_{- ∞}^{+ ∞} {s}_{i} ( λ ) \cdot s ( λ ) d λ$$

Although the spectrum of light arriving at the eye from a given direction determines the color sensation in that direction, there are many more possible spectral combinations that result in the same color sensations. In colorimetry, the term metamerism refers to the matching of a same apparent color of light signals with different spectral power distributions. Color spectra that match this way are called metameric spectra. Based on Equation (1), the mathematical definition of metamerism would be ∀λ∈ [symbol] :

$$∃ λ ∈ [ 380 , 780 ] \cdot {s}_{1} ( λ ) \neq {s}_{2} ( λ ) \qquad ( 2 a )$$

$${\int }_{- ∞}^{+ ∞} {s}_{1} ( λ ) \cdot l ( λ ) d λ = {\int }_{- ∞}^{+ ∞} {s}_{2} ( λ ) \cdot l ( λ ) d λ \qquad ( 2 b )$$

$${\int }_{- ∞}^{+ ∞} {s}_{1} ( λ ) \cdot m ( λ ) d λ = {\int }_{- ∞}^{+ ∞} {s}_{2} ( λ ) \cdot m ( λ ) d λ \qquad ( 2 c )$$

$${\int }_{- ∞}^{+ ∞} {s}_{1} ( λ ) \cdot s ( λ ) d λ = {\int }_{- ∞}^{+ ∞} {s}_{2} ( λ ) \cdot s ( λ ) d λ \qquad ( 2 d )$$

where s1(λ) and s2(λ) are the spectral responses of two metameric (yet different) spectra.

Embodiments described herein are designed to benefit from the visual fusion of the human visual system and more particularly, the unification of visual excitations from the corresponding retinal images of adjacent pixels into a single visual percept.

The term spatial resolution refers to the distance between independent measurements, or the physical dimension that represents a pixel of an image. It is thus the distance between two adjacent pixels of a displayed image.

Visual acuity of human eye limits the spatial resolution that the visual system can process. According to various studies performed, human visual system can discern spatial differences of ~0.6 arcminutes. As 1′×π/(60×180)=0.0002909 rad, 0.6 arcminutes=0.0001745328 rad. Above a given distance, two adjacent pixels cannot be resolved, they are perceived as a single pixel. The luminous power from the various subpixels is summed up and this gives the apparent continuity of images as seen on a screen. This is the notion of spatial fusion that is used in the embodiments described below.

For example, the usual viewing distance for a mobile phone screen is 25-30 cm. So, if the distance between two-point size light sources is less than 0.044-0.052 mm, they will appear as single source. For a TV screen, if the distance between two-point size light sources is less than 0.52 mm, they will appear as single source.

FIG. 2B illustrates examples of contrast sensitivity functions (CSF). CSF relates the visibility of a spatial pattern to both its size and contrast and is therefore a more comprehensive assessment of visual function than acuity, which only determines the smallest resolvable pattern size. CSF depends on luminance and field size.

We use these principles to determine a pair of colors that, when being spatially combined, is perceived by a human observer as another (single and stable) color. Indeed, the technical effect used in the invention relies on the visual fusion characteristic of the human vision system, i.e., the unification of visual excitations from the corresponding retinal images of the complementary neighboring pixels into a single visual percept. In other words, when visualizing a display of spatially alternating complementary colors, the human visual system perceives a single corresponding color that visually has the same perceptual characteristics.

Therefore, the high-level principle of the invention can be considered as adding a dimension to the image signal by replacing a color by two visually complementary colors and using this added dimension to minimize the energy consumption. This principle is herein named spatially alternating complementary colors (SACC). The two adjacent pixels of spatially alternating complementary colors would be perceived by the user as a single pixel.

The term visual fusion relates to the fusion between the colors while the term spatial fusion relates to the fusion between pixels. We use these terms interchangeably in this document since the embodiments relate to the fusion of the colors of spatially adjacent pixels.

Different embodiments propose different solutions for setting the color of a pair of adjacent pixels of an original image to a pair of spatially alternating complementary colors. At least one embodiment is based on pixel doubling (it may also be understood as pixel splitting). In other words, the number of pixels of an input image is doubled to create the needed adjacent pixels, either in width only or in height only or in both dimensions, thus adding new “duplicated” pixels forming the second half of the pair of adjacent pixels. A pixel of the original image is replaced by two pixels of same color (thus the notion of splitting). The pair of adjacent pixels (an original pixel and a duplicated pixel) is then replaced by a pair of pixels of spatially alternating complementary colors, in other words, the pair of spatially alternating complementary colors are assigned to the adjacent pixels. In the case where the original content sent to a display is of a lower resolution than the resolution of the display, some internal upsampling is usually undergone inside the display itself. In such case, this upsampling may be replaced by this first embodiment based on pixel doubling which implicitly uses an upsampled resolution.

At least one embodiment is based on pixel skipping where one pixel over two is set free by cancelling the content initially displayed on it, and the pair of spatially alternating complementary colors is determined based on the color of the first pixel of each adjacent pair of pixels of the original image only, thus no more taking into account the color of the second pixel of the original pair. This allows to set the colors of an original pair of adjacent pixels by a pair spatially alternating complementary colors: the first pixel of the original pair being assigned the first color of the pair of spatially alternating complementary colors, and the second pixel of the original pair being assigned the second color of the pair of spatially alternating complementary colors.

At least one embodiment is based on pixel averaging where the pair of spatially alternating complementary colors is determined based on an average color computed from the colors of the first and second pixels of the adjacent pair of pixels of the original image. The first pixel of the original adjacent pair is assigned the first color of the pair of spatially alternating complementary colors and the second pixel of the original adjacent pair is being assigned the second color of the pair of spatially alternating complementary colors. Unlike the second embodiment based on pixel skipping, this embodiment takes into account the colors of all the pixels of the original image or video.

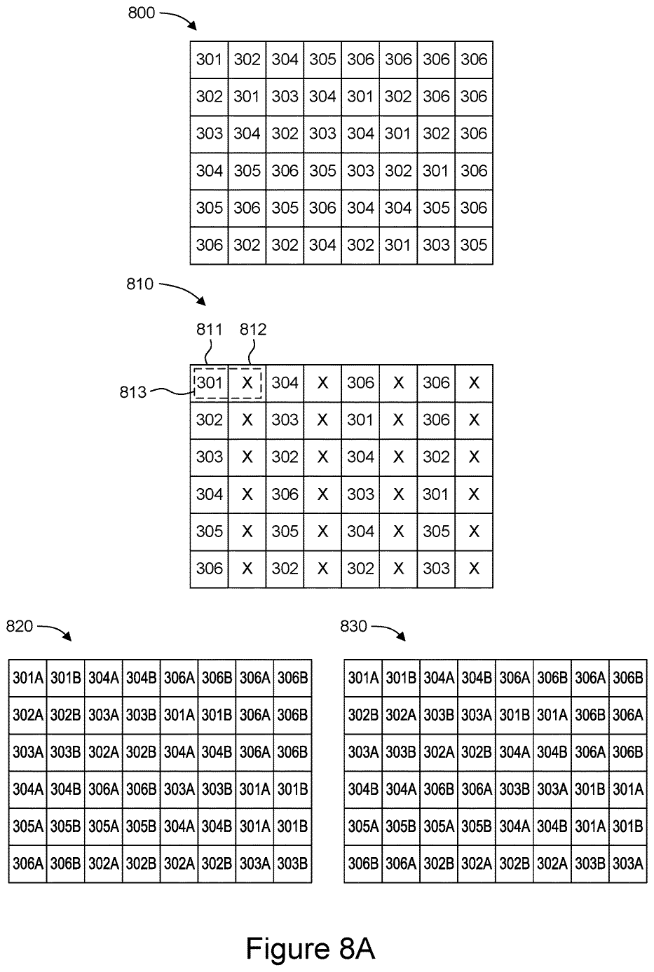

For all three embodiments, different arrangements of adjacent pixels can be used, for example based on stripe patterns, mosaic patterns or random patterns, as further described in relation with FIG. 7.

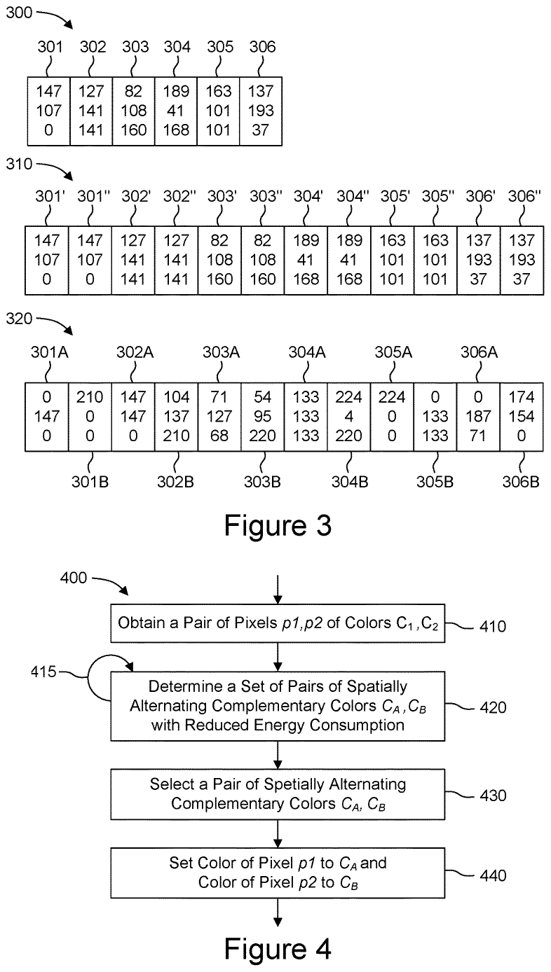

FIG. 3 illustrates examples of decomposition of colors into spatially alternating complementary colors according to embodiments. In this figure, the line 300 corresponds to an extract of an original image and represents a line of pixels 301 to 306. The three numbers inside each block correspond to the color of the corresponding pixel, represented by RGB values expressed using an 8-bit depth. For example, the first pixel is defined by the following values for the color components of the pixel: 147 for red, 107 for green and 0 for blue. This results in a brown pixel. The colors of the other pixels are respectively medium grey for second pixel 302, navy blue for the third pixel 303, dark magenta for the fourth pixel 304, reddish brown for the fifth pixel 305, and bright green for the sixth pixel 306.

The figure illustrates the embodiment based on pixel doubling in the horizontal direction. For that, it is necessary to duplicate the pixels 301 to 306, thus leading to the line 310 where for example the pixel 301 is duplicated into pixels 301′ and 301″. In this embodiment, the adjacent pixels whose color is to be replaced are horizontally adjacent, in other words, the pixels 301′ and 301″ for a pair of adjacent pixels, the next pair is 302′ and 302″, and so on up to the pair 306′ and 306″.

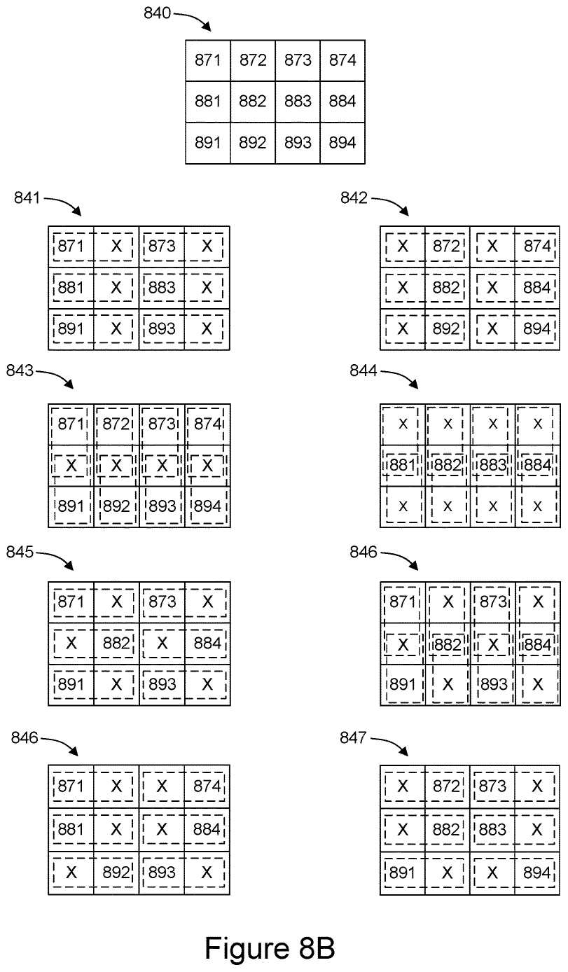

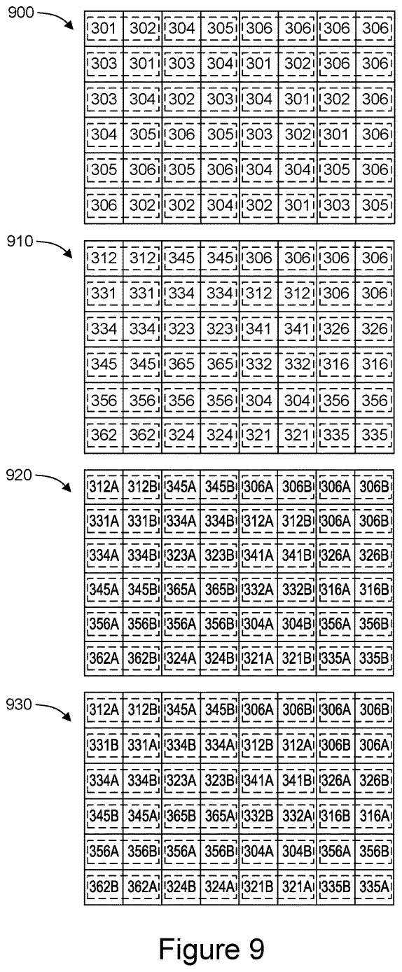

Line 310 shows a set of pairs of pixels (301A, 301B to 306A, 306B) having spatially alternating complementary colors and used to replace the original pixels 301 to 306. Similar to line 300, the values inside the blocks represent the colors of the pixels. Thanks to the spatial fusion of the human visual system, the spatial arrangement of the green pixel 301A and the red pixel 301B is perceived by a human observer as a brown pixel similar to pixel 301, or more generally to the combination of pixels 301′ and 301″. A complete example is described below in relation with FIG. 7. In other embodiments, for example when increasing the image resolution is not possible, other techniques are used, such as pixel skipping or pixel averaging. Examples of such methods are described below in relation with FIGS. 8A, 8B and 9.

FIG. 4 illustrates an example of process for reducing the energy consumption for a pixel of an image using spatially alternating complementary colors according to embodiments. The process 400 is for example implemented by a processor 101 of the device 100 of FIG. 1. In at least one embodiment, the process 400 is iterated over a set of colors comprising colors of all pixels of an input image. In another embodiment, the process 400 is iterated over a set of colors comprising all possible color values according to a selected color space. In other embodiments, the iteration is done over a subset of the pixels or a subset of the color space.

This process is a general process for which some of the steps comprise some variations needed to implement the three embodiments introduced above.

In step 410, the processor obtains the color C₁ and C₂. of a pair of adjacent pixels p1 and p2. For the embodiment based on pixel doubling, prior to this step, the processor needs first to create a new adjacent pixel p2 for the pixel p1, for example by doubling the width of the image. In this case, the pixel p2 is created as a copy of the pixel p1, in other words, its color C₂ is identical to the color C₁. For the embodiment based on pixel skipping, the color of the pixel p2 is replaced by the color of p1. For the embodiment based on pixel averaging, the color of the pixel p1 is replaced by the average color between the colors of p1 and p2.

In step 420, the processor determines a pair of spatially alternating complementary colors C_{A}, C_{B} corresponding to colors C₁ and C₂. The pair of spatially alternating complementary colors is selected based on two constraints. The first constraint is related to the quality of experience and ensures that a combination of adjacent pixels p_{A} and p_{B} of colors C_{A} and C_{B} is perceptually similar to a combination of the pixels p1 and p2 of colors C₁ and C₂. The second constraint is related to the reduction of the energy required for display and ensures that the energy required to display the pixels p_{A} and p_{B} of colors C_{A} and C_{B} is lower than the energy required to display the pixels p1 and p2 of colors C₁ and C₂. The step 420 comprises selecting a first color C_{A} according to a certain criteria described in further embodiments and then determining the appropriate second color C_{B} according to the perceptual similarity and energy reduction constraints. This results into the definition of a pair of colors corresponding to the input colors C₁ and C₂. The step 420 is iterated multiple times (415) to determine a set of alternating complementary colors candidate pairs {C_{AB}}.

In at least one embodiment, the pair of spatially alternating complementary colors C_{A}, C_{B} is determined based on a unique input color C_{IN}.

In step 430, the processor selects one of the candidate pairs C_{A}, C_{B} as the pair of spatially alternating colors to replace the pixel of color C_{IN}. In at least one embodiment, the processor selects the candidate pair that has the lowest energy consumption.

In step 440, the processor replaces the adjacent pixels p1 and p2 of colors C₁ and C₂ by the two adjacent pixels p_{A} and p_{B} of colors C_{A} and C_{B} according to one of the techniques presented herein. In other words, the colors of adjacent pixels p1 and p2 are respectively set to colors C_{A} and C_{B}.

With regards to color similarity, the verification of the first constraint is based on comparing the average of the pair of colors cA, cB to the color cIN. The average of the color pair is computed in a display color space, in a standard color space or in a color space representative of human color vision. Examples of display color spaces are sRGB, AdobeRGB. Examples of standard color spaces (also known as measurement color spaces) are CIEXYZ, CIELUV. Examples of color spaces representative of human color vision (also known as uniform color spaces) are CIELab, IPT, OKLab, OSA-UCS. The resulting color of the display of the processed images with regards to the human perception is therefore the desired color as in the source images, whereas energy consumption is lessened thanks to the adequate choice of (cA, cB) color pair depending on a display color power model.

With regards to energy consumption, in embodiments using frame doubling, the verification of the second constraint is based on comparing the energy of the two temporally successive pixels p_{A} and p_{B} of colors c_{A} and c_{B} respectively to the pixel p of color c, where the duration of display of the temporally successive pixels p_{A} and p_{B} is half the duration of the pixel p. The energy as expressed throughout this document is based on a display color power model. A simple example of such model is based on the sum of the RGB pixel values to the power of a gamma, with gamma between 1.8 and 2.3, for example 2.2. For example, the pixel 302 of FIG. 3 whose RGB values are 127, 141, 141 would be represented by a color power value of (127^{2.2}+141^{2.2}+141^{2.2})=149480. The first pixel 302A of the temporally successive pixels whose RGB values are 147, 147, 0 would be represented by a color power value of ½×(147^{2.2}+147^{2.2}+0^{2.2})=29420. The second pixel 302B of the temporally successive pixels would be represented by a color power value of103042. As illustrated in Table 1, the energy comparison would lead to the conclusion that it is more efficient to replace the pixel 302 (color power value of 149480) by the combination of the pair of temporally successive pixels 302A and 302B (combined color power value of 132462, thus lower).

TABLE 1

| Pixel | 302 | 302A | 302B | 302A + 302B |
|---|---|---|---|---|
| RGB values | 127, 141, 141 | 147, 147, 0 | 104, 137, 210 | 125, 142, 105 |
| Power Value | 149480 | 29420 | 103042 | 132462 |

Colors presented to the human observer are defined by the display response to a RGB triplet, response defined for example within a sRGB or BT-709 or other display color space implemented in a display instance or model, with given parameter adjustments (brightness, contrast, color temperature, etc.). A color space {C} is chosen, in which color arithmetic operations are realized. A display, with colors represented in {C}, has a gamut {G} representing the complete subset of colors the display can render. For an image or video, the colors C₁ and C₂ of each pair of pixels p1 and p2 are replaced by colors C_{A} and C_{B} so that visually the spatial combination of C_{A} and C_{B} gives a color perception close to either C₁ or the average of colors C₁ and C₂ and the energy consumption for displaying the pair of colors C_{A} and C_{B} is lower than the energy consumption for displaying the pair of colors C₁ and C₂.

The iterations on step 420 lead to the creation of a set of spatially alternating complementary colors candidate pairs {C_{AB}}. From this set, a preferred candidate pair (for example the one with the lowest energy consumption) may be chosen for a given input, therefore creating an association between an input color and a pair of spatially alternating complementary colors. In at least one embodiment, this association is stored in a look-up table. This would prevent a display device to have to perform all iterations of steps 420 again for each image and would allow a faster implementation. Therefore, at least one embodiment comprises the steps 410, 420, 430, for example iterated over all possible colors of the gamut, therefore leading to the creation of a look-up table and another embodiment comprises only the steps 410, 430 and 440 iterated over all the pair of pixels of an input image to lead to a modified image that consumes less energy for display.

The input of the look-up table is a single input color. In embodiments based on pixel doubling, this input color is the color of the first pixel of the adjacent pair of pixels. In embodiments based on pixel dropping, this input color may be the color of the first pixel or of the second pixel of the adjacent pair of pixels, depending on which pixel is to be dropped (i.e., not necessarily the first one). In embodiments based on pixel averaging, this input color is the average color between colors of the first pixel and the second pixel of the adjacent pair of pixels.

FIG. 5 illustrates an example of process for establishing the pair candidates of spatially alternating complementary colors according to a first embodiment. The process 500 is for example implemented by a processor 101 of the device 100 of FIG. 1 and corresponds to the step 420 of FIG. 4. It is described here according to an embodiment based on pixel averaging. The process is operated on a pair of adjacent input pixels p1 and p2 whose colors are respectively represented by the input color triplets R₁G₁B₁ and R₂G₂B₂.

In step 510, the processor determines the energy consumption [symbol] for the pair of adjacent input pixels p1 and p2 according to a selected color power consumption model.

$${𝒫}_{IN} = 𝒫 ( {R}_{1} {G}_{1} {B}_{1} ) + 𝒫 ( {R}_{2} {G}_{2} {B}_{2} )$$

The power consumption model is display dependent. For OLED displays, the power consumption model can follow the color model, including the RGBW case where a white LED supports the RGB LEDs for each physical pixel. A color model for a RGBW display is given by the Murdoch et al. in “Perfecting the color reproduction of RGBW OLED” proc. 30th International Congress of Imaging Science. This model can be extended with adequate parameters to represent per pixel power.

In step 520, the processor determines the average color point C_{IN} between p1 and p2 corresponding to the average between the input color triplets R₁G₁B₁ and R₂G₂B₂ within the gamut {G} of the color space {C}. The color space for this figure is selected amongst a display color space, a standard color space, or a human vision color space. In embodiments based on pixel doubling or pixel dropping, the averaging computation may be omitted since only a single color is considered so that C_{IN} is the color of a selected pixel (i.e., the one that is being doubled or the one that is not dropped).

In step 530, the processor samples the color space {C} within the gamut {G} to determine a set of candidate colors {C_{A}} for the first pixel of the spatially adjacent pixels. Different criteria may be used to determine the sampling space. In at least one embodiment, a maximal color distance criterion is used to limit the sampling to the color space around C_{IN}. In various embodiments, the set of candidates comprises saturated colors, or greyscale colors (i.e., part of the grey ramp), or colors having the same luminance than C_{IN} or a combination of these colors. In at least one embodiment, all the color gamut space is explored and thus the set of candidates is the full set of possible values. In at least another embodiment, a subset of the color gamut space is chosen, for example using a smaller color resolution. In another embodiment, a number of randomly selected candidates are used.

The process is then iterated over the steps 540 to 590 to build the set of candidate color pairs for each color of the set of candidate colors {C_{A}} for a first pixel of the adjacent pixels. In step 540, the processor determines, for a selected color C_{A}, a second color C_{B} for a second pixel of the adjacent pixels such that:

$${C}_{B} = 2 \cdot {C}_{IN} - {C}_{A} ,$$

or in another way, such that 2. C_{IN}=(C_{A}+C_{B}).

This ensures that the spatial combination of adjacent pixels of colors C_{A} and C_{B} will look similar to a pixel of color C_{IN} since C_{IN} is the average of colors C_{A} and C_{B} in the color space {C}.

In step 550, the processor verifies that the color C_{B} is comprised in the gamut {G} of the color space {C}. Indeed, if the color is out of the gamut range, it cannot be displayed so that the combination of C_{A} and C_{B} sub-pixels will not be perceptually the same as a pixel of color C_{IN}. If the color is out of the gamut, the iteration stops for the selected value of C_{A} since it does not lead to a correct pair of colors for the adjacent pixels of spatially alternating complementary colors. In this case, the process starts again the iteration with step 540 for the next value of C_{A} if any is remaining in the set.

In step 560, the processor determines the corresponding triplets R_{A}G_{A}B_{A}, R_{B}G_{B}B_{B} for the pair of colors C_{A}, C_{B}.

In step 570, the processor determines the energy consumption P_{AB} of the combination of pixels of colors C_{A}, C_{B}. Since the power consumption model of the display device is not necessarily known, the energy consumption for displaying a color can simply be approximated by the sum of its RGB values to the power gamma as illustrated in table 1. This is evaluated for the selected color power consumption model as:

$${𝒫}_{A B} = 𝒫 ( {R}_{A} {G}_{A} {B}_{A} ) + 𝒫 ( {R}_{B} {G}_{B} {B}_{B} )$$

In step 580, the processor verifies that [symbol] < [symbol] . Indeed, a candidate pair of colors for the adjacent pixels is only considered when it brings some energy reduction. In other words, a candidate pair of alternating complementary colors is considered when the sum of the energies of the pair of pixels of alternating complementary colors is lower than the sum of the energies of the original pair of pixels. If it is not the case, then the candidate pair is discarded, and the process starts again the iteration with step 540 for the next value of C_{A} if any is remaining in the set.

In step 590, the processor adds the candidate pair C_{A}, C_{B} to the set of candidate pairs {C_{AB}}.

In step 430, the processor selects one of the candidate pairs C_{A}, C_{B} as the spatially alternating complementary colors to replace the colors C₁ and C₂. of pixels p1 and p2. In at least one variant, the processor identifies in the list of the candidate pairs {C_{AB}} the position of the candidate pair that has the lowest energy consumption:

$$x min = arg min \{ 𝒫 ( {R}_{A} {G}_{A} {B}_{A} ) + 𝒫 ( {R}_{B} {G}_{B} {B}_{B} ) \}$$

As a result, the processor determines {C̅_̅{̅A̅}̅C̅_̅{̅B̅}̅}ₓₘᵢₙ as being the best replacement. Replacing a pair of colors C₁ and C₂ of adjacent pixels p1 and p2 by two colors C_{Axmin} and C_{Bxmin} will allow to reduce the power consumption when displaying the pixels while keeping an excellent quality of experience since the adjacent pixels of spatially alternating complementary colors will be perceived by a human observer as similar to the combination of pixels p1 and p2 of colors C₁ and C₂.

In at least one embodiment, the selection of the best candidate pair is done directly in step 590. The process does not use a list of candidates but handles a single candidate. A new candidate, as provided in step 580, is compared to the previously selected candidate and the one with the lowest energy consumption is then kept as selected candidate (starting with the first candidate by default).

In at least one embodiment, the correspondence between an input color C_{IN} and its best color pair replacement C_{Axmin}, C_{Bxmin} is stored in a look-up table introduced with regards to FIG. 4 so that the subsequent modifications can be done very efficiently. Providing the input color to the look-up table would allow to get immediately the corresponding color pair without having to perform again the processes 400 of FIG. 4.

In at least one embodiment, a mathematical minimization method, for example a Least Squares minimization, is used to replace the step 520 to 590 to find the correspondence between a color pair C₁ and C₂ and its best color pair replacement C_{Axmin}, C_{Bxmin}.

In at least one embodiment, an additional step is added between steps 520 and 530 to check that the pair of adjacent pixels p1 and p2 spatially belongs to a subset of the image that we want to process, for example belonging to a region in the image having the highest ability to mask artefacts. Such a region or mask can be given by for example a spatio-temporal just noticeable difference (JND) map, a motion field, a saliency map, etc. If the pair of adjacent pixels p1 and p2 does not belong to this region or mask, no color pair replacement will be considered for this pair of adjacent pixels.

In at least one embodiment, the triplets {R_{IN}G_{IN}B_{IN}} are ordered according to their consumed energy so that the triplets are processed in decreasing order from the highest consuming to the lowest consuming ones. In such a case, a threshold might be defined corresponding to a global energy reduction to achieve. When this threshold is reached for a given number of triplets processed, the global process is stopped. Other ordering criteria may be defined, such as determining on a display which are the RGB combinations which consume energy and can be replaced with maximum effect. A map in the color space can be built storing the replacement power ratio

$${R}_{p} = \frac{P ( {C}_{IN} )}{P ( {C}_{Axm i n} ) + P ( {C}_{Bxm i n} )}$$

and the set of colors is sorted by decreasing Rₚ_{ᵣ} before the replacement is made for image pixels. Other examples of ordering would be to make it depending on the distance between the input color and the replacement colors, or to select first the RGB value at the limit of the gamut, or to select according to decreasing saturation values.

FIG. 6 illustrates an example of process for establishing the pair candidates of spatially alternating complementary colors according to a second embodiment in a color space providing color transforms and inverse color transforms. The process 600 is for example implemented by a processor 101 of the device 100 of FIG. 1 and corresponds to the step 420 of FIG. 4. The difference with the first embodiment is that the operations are performed in a color space providing color transforms and inverse color transforms. Examples of such color spaces are the CIE XYZ color space used herein, or the OKLab color space.

When using CIE XYZ, a color is defined by a triplet of coordinates in the XYZ space where Y is the luminance, Z is quasi-equal to B, and X is a mix of the three RGB curves. A compression/expansion transform is first applied (also named “applying a gamma” or “companding”), i.e., elevating each RGB value to the power of a gamma value, which is display dependent. A forward color transform [symbol] (RGB) then allows to compute XYZ coordinates from RGB values and an inverse color transform [symbol] (XYZ) apply inverse operations, i.e., allows to compute the RGB values from XYZ coordinates, also followed by the inverse companding operation.

The process 600 is operated on a pair of adjacent input pixels p1 and p2 whose colors are respectively represented by the input color triplets R₁G₁B₁ and R₂G₂B₂.

In step 610, the processor determines the energy consumption [symbol] for the pair of adjacent input pixels p1 and p2 according to a selected color power consumption model.

$${𝒫}_{IN} = 𝒫 ( {R}_{1} {G}_{1} {B}_{1} ) + 𝒫 ( {R}_{2} {G}_{2} {B}_{2} )$$

In step 620, the processor determines the average color point C_{IN} between p1 and p2 corresponding to the average between the input color triplets R₁G₁B₁ and R₂G₂B₂ within the gamut {G} of the color space {C}. In embodiments based on pixel doubling or pixel dropping, the averaging computation may be omitted since only a single color is considered so that C_{IN} is the color of a selected pixel (i.e., the one that is being doubled or the one that is not dropped).

In step 630, the processor applies a RGB to XYZ forward color transform on the R_{IN}G_{IN}B_{IN} triplet to obtain the X_{IN}Y_{IN}Z_{IN} coordinates in the XYZ space. The forward color transform is display dependent. An example of color transform is the sRGB to XYZ matrix where the white point corresponds to the CIE standard illuminant D65. In step 640, the processor samples the color space {C} within the gamut {G} to determine a set of candidate colors {C_{A}} for the adjacent pixels of spatially alternating complementary colors. The coordinates X_{A}Y_{A}Z_{A} of candidate colors may verify certain conditions. In a first variant, X_{A}=Y_{A}=Z_{A} so that the chosen C_{A} color is part of the grey ramp (i.e., a greyscale color). In a second variant, one of the X_{A} or Y_{A} or Z_{A} coordinates is set to zero so that the chosen C_{A} color is a saturated color. In a third variant, Y_{A}=Y_{IN} so that the chosen C_{A} color has no or minimal variation in luminance compared to the input color, thus getting closer to equiluminance. In a fourth variant, Y_{A}=α·Y_{IN} with α∈[0.8, 1.2] so that it minimizes variations in luminance compared to the input color (quasi-equiluminance).

Then the process is iterated over the steps 650 to 690 to build the set of candidate color pairs for each color of the set of candidate colors {C_{A}} for the adjacent pixels of spatially alternating complementary colors. In step 650, the processor determines, for a selected color C_{A}, a second color C_{B} of coordinates X_{B}Y_{B}Z_{B} such that the color is symmetrical to C_{A} with regard to C_{IN} in the color space. In the selected color space, this is simply done using the following computation:

$$\{ \begin{matrix}{X}_{B} = 2 \cdot {X}_{IN} - {X}_{A} \\ {Y}_{B} = 2 \cdot {Y}_{IN} - {Y}_{A} \\ {Z}_{B} = 2 \cdot {Z}_{IN} - {Z}_{A}\end{matrix}$$

In step 655, the processor verifies that the color C_{B} is comprised in the gamut {G} of the color space {C}. Indeed, if the color is out of the gamut range, it cannot be displayed so that the combination of C_{A} and C_{B} sub-pixels will not be perceptually the same as a pixel of color C_{IN}. If the color is out of the gamut, the iteration stops for the selected value of C_{A} since it does not lead to a correct pair of colors for the temporally successive pixels. In this case, the process starts again the iteration with step 650 for the next value of C_{A} if any is remaining in the set.

In step 660, the processor determines the corresponding triplets R_{A}G_{A}B_{A}, R_{B}G_{B}B_{B} for the pair of colors C_{A}, C_{B} by applying the inverse transform: R_{A}G_{A}B_{A}= [symbol] (X_{A}Y_{A}Z_{A}) and R_{B}G_{B}B_{B}= [symbol] (X_{B}Y_{B}Z_{B}). In step 670, the processor determines the energy consumption of the combination of the pixels of colors C_{A}, C_{B}. This is evaluated using the selected color power consumption model, for example as:

$${𝒫}_{A B} = 𝒫 ( {R}_{A} {G}_{A} {B}_{A} ) + 𝒫 ( {R}_{B} {G}_{B} {B}_{B} )$$

In step 680, the processor verifies that [symbol] < [symbol] . Indeed, a candidate pair of colors for the adjacent pixels is only considered when it brings some energy reduction. In other words, a candidate pair of alternating complementary colors is considered when the sum of the energies of the pair of pixels of alternating complementary colors is lower than the sum of the energies of the original pair of pixels. If it is not the case, then the candidate pair is discarded, and the process starts again the iteration with step 650 for the next value of C_{A} if any is remaining in the set.

In step 690, the processor adds the candidate pair C_{A}, C_{B} to the set of candidate pairs {C_{AB}}.

In step 430, the processor selects one of the candidate pairs C_{A}, C_{B} as the pair of spatially alternating complementary colors to replace the colors of the pair of adjacent pixels p1 and p2. The multiple variations and embodiments described in the context of FIG. 5 for the selection of one pair from the set of candidate pairs also apply here, including the construction of a look-up table storing the association between an input color and a pair of spatially alternating complementary colors.

A third embodiment is based on the same process as described in FIG. 6 with the difference that the selected color space is a uniform color space (for example: CIELab, IPT, OKLab, or others). Uniform color spaces are built such that the same geometrical distance (2-distance) anywhere in the color space reflects the same amount of perceived color difference. The CIELab color space is selected for the description below. In this color space, a color is expressed as three values: L for perceptual lightness and a and b for the four unique colors opponents of human vision: red and green, blue and yellow. For this embodiment, some variations are required to adapt some of the steps of the process 600 to the uniform color space. In step 630, the processor applies a forward color transform RGB to CIELab on the R_{IN}G_{IN}B_{IN} triplet to obtain the L_{IN}a_{IN}b_{IN} coordinates in the CIELab color space. The forward color transform conventionally comprises a gamma operation. In step 640, the processor samples the color space {C} within the gamut {G} to determine a set of candidate colors {C_{A}} of the adjacent pixels of spatially alternating complementary colors. The coordinates L_{A}a_{A}b_{A} of candidate colors may verify certain conditions. In a first variant, a_{A}=b_{A} so that the chosen C_{A} color is part of the grey ramp (i.e., a greyscale color). In a second variant, set L_{A}a_{A}b_{A} so that its cylindrical version L_{A}C_{A}h_{A} as the same luminance and hue as L_{IN}a_{IN}b_{IN} but maximum chroma. In a third variant, L_{A}=L_{IN} so that the chosen C_{A} color has no or minimal variation in luminance compared to the input color, thus getting closer to equiluminance. In a fourth variant, L_{A}=α·L_{IN} with α∈[0.8, 1.2] so that to minimize variations in luminance compared to the input color (quasi-equiluminance). In step 650, the processor determines, for a selected color C_{A}, a second color C_{B} of coordinates L_{B}a_{B}b_{B} such that the color is symmetrical to C_{A} with regard to C_{IN}. In the uniform color space, this is simply done using the following computation:

$$\{ \begin{matrix}{L}_{B} = 2 \cdot {L}_{IN} - {L}_{A} \\ {a}_{B} = 2 \cdot {a}_{IN} - {a}_{A} \\ {b}_{B} = 2 \cdot {b}_{IN} - {b}_{A}\end{matrix}$$

In step 660, the processor determines the corresponding triplets R_{A}G_{A}B_{A}, R_{B}G_{B}B_{B} for the pair of colors C_{A}, C_{B} by applying the inverse transform: R_{A}G_{A}B_{A}= [symbol] (X_{A}Y_{A}Z_{A}) and R_{B}G_{B}B_{B}= [symbol] (X_{B}Y_{B}Z_{B}). The other steps of process 600 are identical. The multiple variations and embodiments described in the context of FIGS. 5 and 6 also apply to the third embodiment.

FIG. 7 illustrates examples of replacement of a pair of adjacent pixels by a pair of pixels of spatially alternating complementary colors according to an embodiment based on increased resolution. In the figure, the array 700 represents an example of original images to be displayed (i.e., before being modified), here comprising three rows of four pixels each (for the sake of simplicity of the drawings). Each pixel is represented by a rectangle comprising a color value according to the colors defined in FIG. 3. For example, the pixel 701 in the upper left corner is a brown pixel.

In a first variant of such embodiment, the width is doubled compared to the original image. For example, if the input image would have a resolution of 1920 by 1080 pixels, the modified image where the original pixels would be replaced by spatially alternating complementary color pixels would have a resolution of 3840 by 1080 pixels.

The array 710 represents an image based on the original image of array 700 and modified according to this first variant. The processor first inserts additional columns 711, 712, 713, 714 to create duplicate pixels. Then the processor selects a first pair of adjacent pixels, for example pixels 715 and 716. From the color (301) of the first pixel 715 of the first pair of adjacent pixels, the processor determines a pair of spatially alternating complementary colors (301A, 301B) as described above, for example using a look-up table. These colors are then used to set the colors of the pair of adjacent pixels. As a result, the color of pixel 715 is set to 301A while the color of pixel 716 is set to 301B. The process is iterated over all pairs of adjacent pixels and the result is a modified image 710 that, when displayed on a screen, looks similar to the original image 700 but requires less energy for its display.

In a second variant of such embodiment, the height is doubled compared to the original image. For example, if the input image would have a resolution of 1920 by 1080 pixels, the modified image where the original pixels would be replaced by spatially alternating complementary color pixels would have a resolution of 1920 by 2160 pixels.

The array 720 represents an image modified according to the second variant. The process is the same as described in the previous paragraph but adapted to the vertical direction. The insertion is done vertically, thus the lines 721, 722, 723 are inserted. The selection of the adjacent pixel pairs is here vertical. The process leads to a modified image where the colors of the first pixels of the first column are respectively set to 301A and 301B.

In a third variant of such embodiment, both the width and the height are doubled compared to the original image. For example, if the input image would have a resolution of 1920 by 1080 pixels, the modified image where the original pixels would be replaced by spatially alternating complementary color pixels would have a resolution of 3840 by 2160 pixels. In other words, each pixel would be replaced by a set of four pixels of two spatially alternating complementary colors. In this case, the second constraint verification related to energy consumption has to be adapted accordingly, i.e., comparing the total power of the four replacement pixels to four times the power of the original pixel.

The array 730 represents an image modified according to the third variant. It combines the insertion of lines and column as described in the two first variants. As a result, the original pixel 701 of array 700 is replaced by a set of 4 pixels 731, 732, 733, 734 with respectively the colors 301A, 301B, 301B and 301A. The determining of the pair of spatially alternating complementary color corresponding to the color 301 of original pixel 701 needs to be done only once. It results on the pair (301A, 301B) that is applied onto the 4 pixels 731, 732, 733, 734 in a mosaic arrangement (i.e., changing the order between the colors of the pair for the second line) to provide a good distribution of the colors.

The first and second variants may be implemented internally in a display panel by physically doubling the number of pixels in one of the directions but without providing access to the additional pixels to the outside world.

The third variant is of more general use. Indeed, the resolution of content currently available is often inferior to the capabilities of the display device. It is quite common to have a full HD content (1920×1080) displayed on a UHD-capable (3840×2160) or 4K-capable (4096×2160) device. Therefore, this technique could be considered as a simple upscaling function that while providing the additional pixels for the upscaling also provides a reduction of the energy required for displaying the upscaled image.

In these embodiments, the first pixel of a pair of pixels is always replaced by the first color of the pair of spatially alternating complementary colors. In at least one embodiment, an alternance is introduced between lines (respectively columns) regarding the order of selection of the pair of colors. In a first line (respectively column), the color of the first pixel of a pair of pixels is replaced by the first color of the pair of spatially alternating complementary colors and the color of the second pixel of a pair of pixels is replaced by the second color of the pair of spatially alternating complementary colors but in the second line (respectively column), the color of the first pixel of a pair of pixels is replaced by the second color of the pair of spatially alternating complementary colors and the color of the second pixel of a pair of pixels is replaced by the first color of the pair of spatially alternating complementary colors.

FIGS. 8A and 8B illustrate examples of adjacent pixel replacement by pixels of spatially alternating complementary colors according to an embodiment based on pixel skipping. This method may be used for example when it is not possible to increase the resolution of the image, typically when the image to be displayed has the same resolution as the display. In FIG. 8A, the array 800 represents an image comprising 6 rows of 8 columns of pixels, each pixel being represented by a rectangle comprising a color value according to the colors defined in FIG. 3.

This embodiment is based on skipping (dropping) one column out of two, as illustrated in the array 810 where the dropped pixels are represented by an ‘X’ symbol. In this case, the pair of adjacent pixels is a horizontal pair. For example, the pair of adjacent pixels 813 comprises the pixels 811 and 812, and the value of the pixel 812 is skipped, i.e., will not be considered to determine the pair of spatially alternating complementary colors. In at least one embodiment, the skipped pixels are replaced by copies of the adjacent pixels. In other embodiment, no action is taken effectively on the value of the pixel since it is simply not considered by the processes described above.

The pixels of the array 810 are then used by one of the algorithms described above to determine the pixels of spatially alternating complementary colors, thus leading to the array 820. This array 820 shows an implementation where the color of the first pixel (in the upper left corner, its original color was 301) of the first horizontal pair of pixels is replaced by the color 301A corresponding to the first color of the pair of spatially alternating complementary colors determined for the color value 301, while the color of the second pixel (original value was 302 but was dropped) of the first pair of pixels is replaced by the color 301B, corresponding to the second color of the pair of spatially alternating complementary colors determined for the color value 301.

In this scheme, the first pixel of a pair of pixels is always replaced by the first color of the pair of spatially alternating complementary colors. In a different scheme illustrated in array 830, an alternance is introduced between lines regarding the order of selection of the pair of colors. In a first line, the color of the first pixel of a pair of pixels is replaced by the first color of the pair of spatially alternating complementary colors and the color of the second pixel of a pair of pixels is replaced by the second color of the pair of spatially alternating complementary colors but in the second line, the color of the first pixel of a pair of pixels is replaced by the second color of the pair of spatially alternating complementary colors and the color of the second pixel of a pair of pixels is replaced by the first color of the pair of spatially alternating complementary colors. This is particularly interesting in uniform areas. This is visible in the upper right corner where such solution provides a (mosaic-style) good spreading of colors 306A and 306B in an area that was originally having a uniform color 306.

FIG. 8B illustrates various arrangements for skipping pixels according to an embodiment based on pixel skipping. The array 840 represents an image comprising 3 rows of 4 columns of pixels, each pixel being represented by a different number to identify it in order to better understand the multiple arrangements. In each arrangement, the dropped pixels are represented by a ‘X’ symbol and the pair of adjacent pixels are represented by dashed-line rectangles. In at least one embodiment, the color of the non-dropped pixel is copied to the dropped pixel to provide the inputs needed for the processes 500 of FIG. 5 and 600 of FIG. 6.

Arrays 841 and 842 represent images where the pairs of adjacent pixels are chosen horizontally. In array 841, the first (left) pixel of the pair is skipped while the second (right) pixel of the pair is skipped in array 842. The result is two arrangements of identical shape but with different color values.

Arrays 843 and 844 represent images where the pairs of adjacent pixels are chosen vertically. In array 843, the first (top) pixel of the pair is skipped while the second (bottom) pixel of the pair is skipped in array 844. The result is two arrangements of identical shape but with different color values. These arrays also show an example of treatment when the number of pixels in one direction is odd. In this example, the last pair comprises a pixel of the last row and a pixel above.

The array 845 represents an image where the pairs of adjacent pixels are chosen horizontally. In this arrangement, the skipped pixel within a pair is alternated from one line to the other. For example, in the first line of this array, the second (right) pixels of the pairs are skipped (thus pixel 872 and 874) while in the next line, it is the first (left) pixel of the pairs that are skipped (thus pixel 881 and 883) and so on. The array 846 illustrates a similar arrangement but done according to the vertical direction.

Arrays 846 and 847 represent images where the pairs of adjacent pixels are chosen horizontally according to the colors of the pairs. In array 846, the skipped pixels are the pixels with highest energy amongst a pair of pixels. For example, supposing that the pixel 871 requires less energy than pixel 872, this pixel is kept and the pixel 872 is skipped. In array 847, the skipped pixels are the pixels with lowest energy amongst a pair of pixels. As result, the pixel 872 is kept and the pixel 871 is skipped. Other criteria may be used for deciding which pixel is skipped.

In at least one embodiment, the processor generates a plurality of images according to a selection of different embodiments using the different arrangements described above and computes the corresponding total energy for each of the corresponding modified image. The processor selects then the image with the lowest energy as the modified image.

FIG. 9 illustrates examples of color replacement by spatially alternating complementary colors according to an embodiment based on pixel averaging. This method may be used for example when it is not possible to double the display resolution. It is based on averaging the colors of the pair of adjacent pixels. Compared to the pixel skipping technique discussed in relation with FIG. 8, this allows to take into account all pixels of the image.

The array 900 represents an image comprising 6 rows of 8 columns of pixels, each pixel being represented by a rectangle comprising a color value according to the colors defined in FIG. 3. In this embodiment, the possible arrangements for the pairs of adjacent pixels are limited to a selection of either a horizontal or a vertical direction. The arrays 910, 920, 930 illustrate the situation where a horizontal pair arrangement is chosen, as illustrated by the dashed rectangle that represent the pair of adjacent pixels.

In this case, an average color is computed between the pixels of the pairs of adjacent pixels, for example between the two first pixels of the first line of array 900 (color values 301 and 302) leading to an average color (value 312) as shown in array 910. This average value is used according to the process 500 of FIG. 5 or the process 600 of FIG. 6 to determine the pair of colors (312A, 312B) illustrated in array 920 and thus providing a modified image similar to the original image but requiring less energy for display.

In a variant embodiment, the order of the pair of colors is swapped for each line as shown in array 930. In the first line, the color of the first pixel of a pair of adjacent pixels is replaced by the first color (312A) of the pair of spatially alternating complementary colors but in the second line, the color of the first pixel of a pair of adjacent pixels is replaced by the second color (331B) of the pair of spatially alternating complementary colors and so on.

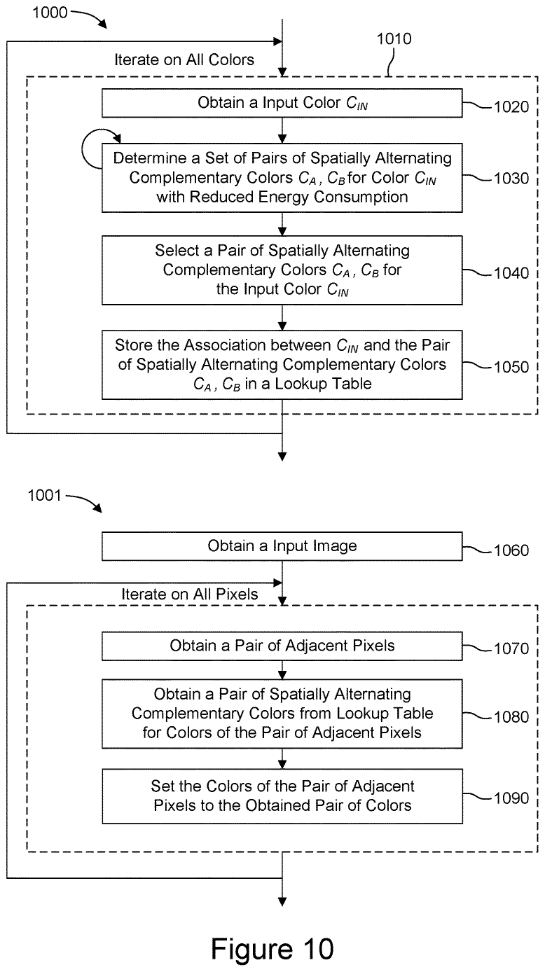

FIG. 10 illustrates an example of process for generating a look-up table for spatially alternating complementary colors according to embodiments and an example of process for modifying an image using the look-up table according to embodiments. These processes are implemented based on embodiments described above.

The process 1000 aims at generating the look-up table of spatially alternating complementary colors. The step 1010 is iterated multiple times. In at least one embodiment, the iterations are done over all possible colors in the color gamut. In at least one other embodiment, the iterations are done over a sub-sampled color space only. In at least one other embodiment, the iterations are done over all colors of a predetermined set of images. Other embodiments may use other subset of colors. It comprises the steps 1020 to 1050. In step 1020, an input color is obtained. In step 1030, a set of pairs of spatially alternating complementary colors corresponding to the input color is determined, for example using one of the embodiments described above. In step 1040, one of the pair of the set is selected, for example the pair providing the best energy performance. In step 1050, the association between the input color and the pair of spatially alternating complementary colors is stored in a look-up table. At the end of process 1000, the look-up table comprises a set of associations between input colors and pairs of spatially alternating complementary colors.

The process 1001 aims at modifying an image using the look-up table. In step 1060, an input image is obtained. In step 1070, a pair of adjacent pixels is selected and, in step 1080, the pair of spatially alternating complementary colors corresponding to one color based on the pair of adjacent pixels is obtained from the look-up table. In step 1090, the colors of the pair of adjacent pixels are set to the pair of spatially alternating complementary colors. The steps 1070, 1080 and 1090 are then iterated over all the pairs of adjacent pixels.

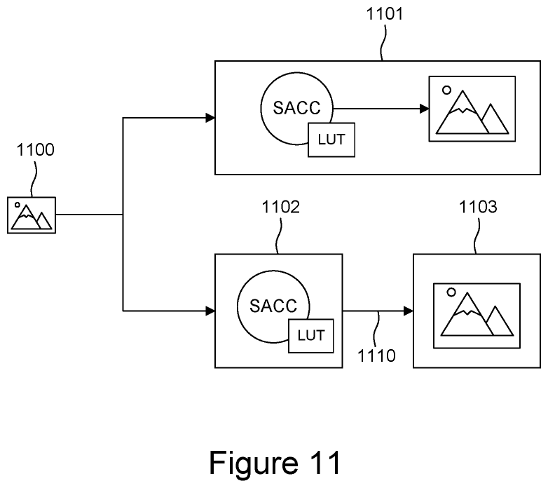

FIG. 11 illustrates two examples of deployment for the spatially alternating complementary color process according to embodiments. In at least one embodiment, the device 1101 is a display device such as the one described in FIG. 1. In this case, the processor 101 of the device 1101 is configured to obtain an input image or video 1100 and displays it on the display unit 103 of FIG. 1 after being processed by the SACC process as described above. In other words, the processor 101 of the device 1001 is configured to obtain an input image or video 1100 and determine a modified image or video to be displayed using spatially alternating complementary colors obtained by using a look-up table that results into an image providing reduced energy consumption of the display device when compared to displaying the original input image. The look-up table may be obtained from a data provider through a communication network and/or from an internal memory of the device. The image or video 1100 may be obtained from a data provider through a communication network, from an internal memory of the device, stored for example after being captured by an input unit. Typical examples of devices 1101 are smartphones, tablets, laptops, external monitors, head-mounted displays, television sets, video projectors, computer screens, vehicles (e.g., control and/or entertainment systems for cars, planes, boats, etc.), advertisement display panels, medical monitors, etc. However, any device or composition of devices that provides similar functionalities can be used as display device 1101 while still conforming with the principles of the disclosure.

In at least one embodiment, the device 1102 does not include a display unit but prepares data for display so that another device 1103, such as a screen, can perform the display. In this case, the processor of the device implements the SACC process described herein and generates a new image or video 1110 that is perceptually similar to the original video but will require less energy when being displayed. This modified video is then provided to a display device 1103 for being presented to a human viewer. Example of such devices 1102 are set top boxes, media players, desktop computers, encoders, decoders, servers, computing grids, cloud computers, etc.

Light production in display devices, including mobile phones and televisions, is costly. Reduction of the amount of light produced is desirable, as this helps to reduce the amount of energy necessary to operate the display. The advantage of this is two-fold: less pressure on the climate, and longer battery life in mobile devices. Relative to other methods that aim to reduce energy consumption for the same reasons, the proposed method, by means of its construction, guarantees that the light emitted by each pixel is produced with a combination of sub-pixels minimizing energy consumption in average. This is meant to be more versatile and thus more efficient than acting on single pixel.

Although different embodiments have been described separately, any combination of the embodiments together can be done while respecting the principles of the disclosure.

Reference to “one embodiment” or “an embodiment” or “one implementation” or “an implementation”, as well as other variations thereof, mean that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout the specification are not necessarily all referring to the same embodiment.

Additionally, this application or its claims may refer to “determining” various pieces of information. Determining the information may include one or more of, for example, estimating the information, calculating the information, predicting the information, or retrieving the information from memory.

Additionally, this application or its claims may refer to “obtaining” various pieces of information. Obtaining is, as with “accessing”, intended to be a broad term. Obtaining the information may include one or more of, for example, receiving the information, accessing the information, or retrieving the information (for example, from memory or optical media storage). Further, “obtaining” is typically involved, in one way or another, during operations such as, for example, storing the information, processing the information, transmitting the information, moving the information, copying the information, erasing the information, calculating the information, determining the information, predicting the information, or estimating the information.

Additionally, the terms “image” and “frame” are used herein interchangeably and are both used to represent a set of pixels, for example arranged in a two-dimensional array. A sequence of multiple images or frames arranged according to a temporal order is conventionally named a “video”.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

1. A method comprising, for an input color of a pixel,
determining, based on the input color of the pixel, a pair of alternating complementary colors comprising a first color and a second color by:
selecting a color value in a color space for the first color according to a selection criterion; and
determining the second color as being the symmetrical color to the first color with regards to the input color if a sum of the energies of a pair of pixels having alternating complementary colors using the first and second colors is lower than twice the energy of a pixel having the input color.

2. (canceled)

3. The method of claim 1, wherein the selection criterion is a maximal color distance from the input color.

4. The method of claim 1, wherein the selection criterion is that the color is a saturated color.

5. The method of claim 1, wherein the selection criterion is that the color is a greyscale color.

6. The method of claim 1, wherein the selection criterion is that the color has the same luminance as the input color.

7. The method of claim 1, wherein the color space is a XYZ color space or a uniform color space.

8. (canceled)

9. The method of claim 1, wherein the determining of the pairs of colors is iterated multiple times to generate a set of pairs of alternating complementary colors, and further comprising selecting the pair of alternating complementary colors of the set of pair of alternating complementary colors having the lowest energy consumption.

10. The method of claim 9, being further iterated over a set of input colors comprising the colors of all pixels of an input image or of a subset of all pixels of the input image or all possible color values of a selected color space or a subset of all possible color values of a selected color space.

11. (canceled)

12. The method of claim 10, further comprising storing an association between the set of input colors and the corresponding determined pair of alternating complementary colors.

13. The method of claim 12, wherein the association is stored in a look-up table using an input color as index.

14. A method comprising:
obtaining a pixel of an image;
obtaining a pair of alternating complementary colors based on the color of the pixel according to claim 1; and
adding new pixels to the image, horizontally or vertically, to double a width or a height of the image to transform a single pixel into a pair of adjacent pixels, wherein the color of the first pixel of the pair of adjacent pixels is set to the first color and the color of the second pixel of the pair of adjacent pixels is set to the second color.

15-22. (canceled)

23. A method comprising:
obtaining a pixel of an image;
obtaining a pair of alternating complementary colors based on the color of the pixel according to claim 1; and
adding new pixels to the image, horizontally and vertically, to double a width and a height of the image to transform a single pixel into a couple of pairs of adjacent pixels, wherein the color of the first pixel of the first pair of adjacent pixels is set to the first color and the color of the second pixel of the first pair of adjacent pixels is set to the second color, and wherein the color of the first pixel of the second pair of adjacent pixels is set to the second color and the color of the second pixel of the second pair of adjacent pixels is set to the first color.

24-29. (canceled)

30. A device comprising one or more processors configured to, for an input color of a pixel,
determine, based on the input color of the pixel, a pair of alternating complementary colors comprising a first color and a second color by:
selecting a color value in a color space for the first color according to a selection criterion; and
determining the second color as being the symmetrical color to the first color with regards to the input color if a sum of the energies of a pair of pixels having alternating complementary colors using the first and second colors is lower than twice the energy of a pixel having the input color.

31-37. (canceled)

38. The device of claim 30, wherein the determining of the pairs of colors is iterated multiple times to generate a set of pairs of alternating complementary colors, and further comprising selecting the pair of alternating complementary colors of the set of pair of alternating complementary colors having the lowest energy consumption.

39. The device of claim 38, being further iterated over a set of input colors comprising the colors of all pixels of an input image or of a subset of all pixels of the input image or all possible color values of a selected color space or a subset of all possible color values of a selected color space.

40. (canceled)

41. The device of claim 39, comprising storing an association between the set of input colors and the corresponding determined pair of alternating complementary colors in a look-up table using an input color as index.

42. (canceled)

43. A device comprising one or more processors configured to:
obtain a pixel of an image;
obtain a pair of alternating complementary colors based on the color of the pixel according claim 30; and
add new pixels to the image, horizontally or vertically, to double a width or a height of the image to transform a single pixel into a pair of adjacent pixels, wherein the color of the first pixel of the pair of adjacent pixels is set to the first color and the color of the second pixel of the pair of adjacent pixels is set to the second color.

44-51. (canceled)

52. A device comprising one or more processors configured to:
obtain a pixel of an image;
obtain a pair of alternating complementary colors based on the color of the pixel according to claim 30,
add new pixels to the image, horizontally and vertically, to double a width and a height of the image to transform a single pixel into a couple of pairs of adjacent pixels, wherein the color of the first pixel of the first pair of adjacent pixels is set to the first color and the color of the second pixel of the first pair of adjacent pixels is set to the second color, and wherein the color of the first pixel of the second pair of adjacent pixels is set to the second color and the color of the second pixel of the second pair of adjacent pixels is set to the first color.

53-58. (canceled)

59. The device of claim 30, wherein the device is selected in a set comprising smartphones, tablets, laptops, external monitors, head-mounted displays, television set, video projectors, computer screens, vehicles control system, vehicles entertainment systems, advertisement display panels, medical monitors.

60. (canceled)

61. A non-transitory computer readable medium comprising program code instructions for implementing the method of claim 1 when executed by a processor.
